(19) United States
(12) Patent Application Publication
(10) Pub. No.: US 2009/0211697 A1
(43) Pub. Date: Aug. 27, 2009

(54) REINFORCED HYBRID STRUCTURES AND METHODS THEREOF

(76) Inventors: Markus B. Heinimann, New Alexandria, PA (US); Michael Kulak, Murrysville, PA (US); Edmund W. Chu, Export, PA (US); John T. Siemon, Cheswick, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/749,027

(22) Filed: May 15, 2007

(51) Int. Cl. B29C 65/00

(52) U.S. Cl. 156/212

(57) ABSTRACT

The present invention discloses a method for producing an aircraft wing hybrid structure comprising the steps of producing a machined metallic bottom skin by either (i) pre-machining, (ii) preforming or (iii) combinations thereof, finishing the machined metallic bottom skin, providing a finished machined metallic bottom skin that serves as a lay-up mold, placing a plurality of core straps on top of the finished machined metallic bottom skin, arranging a skin that is selected from the group consisting of a monolithic skin, a fiber metal laminate skin and a non-reinforced metallic laminate skin on top of the plurality of cores strap to form a module, and curing the module, wherein the finished machined metallic bottom skin is the load carrying element in the aircraft wing hybrid structure. In another embodiment, the present invention discloses a method for producing an aircraft wing hybrid structure comprising the steps of providing a lay-up mold, placing a first skin that is selected from the group consisting of a monolithic skin, a fiber metal laminate skin and a non-reinforced metallic laminate skin on a lay-up mold, placing a plurality of core straps on top of the skin, arranging a second skin that is selected from the group consisting of a monolithic skin, a fiber metal laminate skin and a non-reinforced metallic laminate skin on top of the plurality of cores strap to form a module, and curing the module.

### BACKGROUND OF THE INVENTION

Future commercial aircraft programs will continue to reduce aero-structure weight and acquisition and operating costs to fulfill their missions, fly faster, and carry more payload economically. Static strength, structural fatigue, crack growth and residual strength and damage tolerance requirements are design drivers for single aisle or twin aisle commercial aircraft lower wing stiffened skin panels.

### SUMMARY OF THE INVENTION

In one embodiment, the present invention relates to a product and method for a reinforced hybrid structure for use in aerospace applications. In another embodiment, the method and system for reinforced hybrid structure may be used in other industries. In yet another embodiment, the method and system of the present invention relates to a reinforced hybrid structure where two or more monolithic metal skins or laminated skins or a combination of monolithic and laminated skins are reinforced by a core layer comprised of a metallic laminate or a fiber metal laminate which is placed between every monolithic metal skin or laminated skin. In yet another embodiment, the laminated skins are bonded with a non-reinforced adhesive material or a fiber reinforced adhesive material. In a further embodiment, the cores are bonded to the skins with a non-reinforced adhesive or fiber reinforced adhesive.

In one embodiment, the present invention discloses a method for producing an aircraft wing hybrid structure comprising the steps of: (1) producing a machined metallic bottom skin by either (i) pre-machining, (ii) preforming or (iii) combinations thereof, (2) finishing the machined metallic bottom skin, (3) providing a finished machined metallic bottom skin that serves as a lay-up mold, (4) placing a plurality of core straps on top of the finished machined metallic bottom skin, (5) arranging a skin that is selected from the group consisting of a monolithic skin, a fiber metal laminate skin and a non-reinforced metallic laminate skin on top of the plurality of cores strap to form a module, and (6) curing the module, wherein the finished machined metallic bottom skin is the load carrying element in the aircraft wing hybrid structure. In another embodiment, the core straps comprises at least two metal layers between which there is at least one fiber-reinforce polymer layer. In a further embodiment, the plurality of core straps are selected from the group consisting of non-stretched, pre-stretched and combinations thereof. In yet another embodiment, at least one skin with core combination may be place inside the module where the skin is selected from the group consisting of a monolithic skin, a fiber metal laminate skin and a non-reinforced metallic laminate skin with fiber metal laminate strap cores between each skin.

In another embodiment, the present invention discloses a method for producing an aircraft wing hybrid structure comprising the steps of (1) providing a lay-up mold, (2) placing a first skin that is selected from the group consisting of a monolithic skin, a fiber metal laminate skin and a non-reinforced metallic laminate skin on a lay-up mold, (3) placing a plurality of core straps on top of the skin, (4) arranging a second skin that is selected from the group consisting of a monolithic skin, a fiber metal laminate skin and a non-reinforced metallic laminate skin on top of the plurality of cores strap to form a module, and (5) curing the module. In another embodiment, the core straps comprises at least two metal layers between which there is at least one fiber-reinforce polymer layer. In a further embodiment, the first skin is a fiber metal laminate skin. In yet another embodiment, the second skin is a fiber metal laminate skin. In yet a further embodiment, at least one skin with core combination may be place inside the module where the skin is selected from the group consisting of a monolithic skin, a fiber metal laminate skin and a non-reinforced metallic laminate skin with fiber metal laminate strap cores between each skin.

In one embodiment of the invention, a reinforced hybrid structure for use in aerospace applications and other industrial applications such as transportation vehicles is provided.

In another embodiment of the invention, a reinforced hybrid structure for use as a wing skin in commercial airlines, military aircrafts or applications in other industries is provided.

It is yet another embodiment of the invention, the present invention may result in a wing skin that may have one or more of the following: lighter in weight, more economically to manufacture, improved corrosion resistance performance, reduce fatigue crack growth and/or exhibits low in-service maintenance costs.

These and other further embodiments of the invention will become more apparent through the following description and drawing.

The invention comprises a product possessing the features, properties, and the relation of components which will be exemplified in the product hereinafter described and the scope of the invention will be indicated in the claims.

### BRIEF DESCRIPTION OF THE DRAWINGS

For a fuller understanding of the invention, reference is had to the following description taken in connection with the accompanying drawing, in which:

FIG. 1 is a partial cross-sectional of a reinforced hybrid structure in accordance with one embodiment of the invention.

### DESCRIPTION OF THE PREFERRED EMBODIMENTS

This invention relates to a reinforced hybrid structure, and more particularly to a structure where two or more monolithic metal skins or laminated skins or a combination of monolithic and laminated skins are reinforced by a core layer comprised of a metallic laminate or a fiber metal laminate which is placed between every monolithic metal skin or laminated skin. In one embodiment, the laminated skins are bonded with a non-reinforced adhesive material or a fiber reinforced adhesive material. In another embodiment, the cores are bonded to the skins with a non-reinforced adhesive or fiber reinforced adhesive. In a further embodiment, each core is comprised of a plurality of metallic laminate or fiber metal laminate straps which are pre-stretched or non-stretched and lain side-by side in the core region to fill the area between skins.

In one embodiment, the reinforced hybrid structure may contain at least one module. The module is defined as having two outer layers of a combination of monolithic and/or laminated skins that are reinforced by a middle core layer. In another embodiment, multiple combinations of skins with cores may be added to the inside of the module to create other types of reinforced hybrid structures.

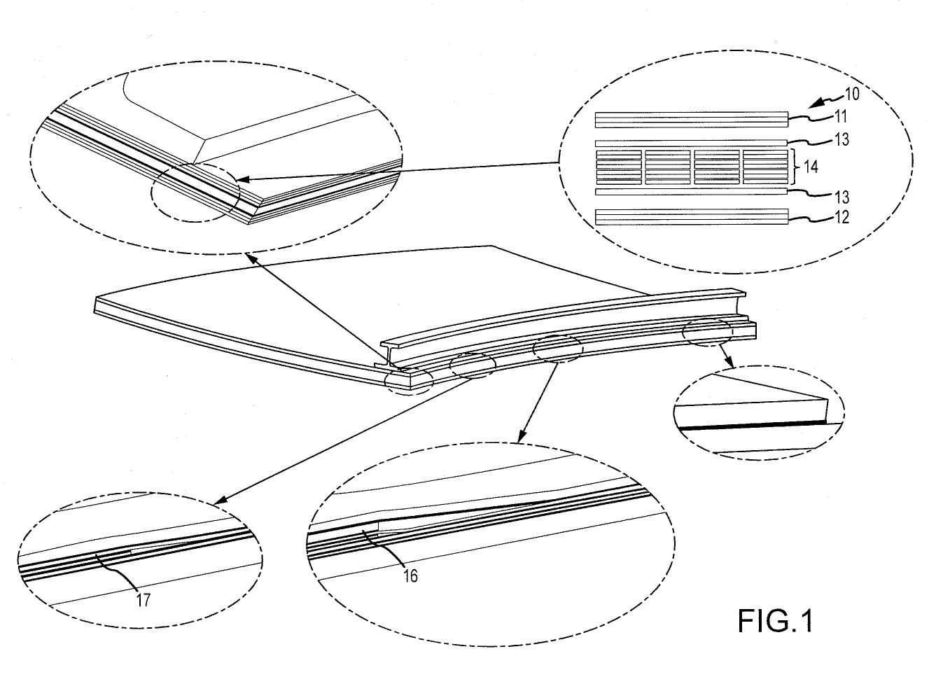

In one embodiment of the present invention, FIG. 1 illustrates a reinforced hybrid structure 10 where a top monolithic skin layer 11 only or both top 11 and bottom 12 monolithic skin layers are replaced by metallic laminate skins bonded together by adhesive or fiber reinforced adhesive 13 (thin metal sheets bonded together). Fiber metal laminate straps 14 referred to as FML straps core materials are sandwiched between the metallic laminate and/or the monolithic metallic skin. The FML straps 14 are securely bonded to the metallic laminate and/or the skin by means of a metal adhesive, and/or fiber reinforced adhesive 13.

In one embodiment, the present invention employs a series of pre-manufactured FML straps lain side-by side in the core regions. In this geometry, the straps are flexible in the length direction and can conform to the complex curved shape required with pressure loading from the autoclave or pressure from molding. In another embodiment, the core FML straps have a relatively narrow width compared to length (e.g. at least a ratio of 10:1 in one example, at least a ratio of 6:1 in another example and at least a ratio of 3:1 in a further example). In another embodiment, when the core gage is in the thickness that exceeds about 6 layers of aluminum/5 layers of fiber reinforced adhesive (where each aluminum layer is the thickness of about 0.008 to about 0.016 inches and each of the fiber reinforced adhesive layer is the thickness of about 0.001 to about 0.005 inches, respectively) to be formed into the required curvature, the core can be divided into thinner, more formable sub-layers which overlap. Examples of this division is 2 layers of aluminum/1 layer of fiber reinforced adhesive in addition to 4 layers of aluminum/3 layers of fiber reinforced adhesive. Another example of this division is 3 layers of aluminum/2 layers of fiber reinforced adhesive in addition to 3 layers of aluminum/2 layers of fiber reinforced adhesive.

In one example, prior to final skin manufacturing process, the pre-manufacturing of the straps and use in this manner to manufacture the final skin allows the straps to be pre-stretched or non-stretched. The straps may be prestretched, non-stretched and or combinations thereof. In another embodiment, a FML sheet may be used in place of the FML straps. However, FML straps are used to reduce the amount of spring back when conforming to the complex curved shape. In another embodiment, core FML straps may be incorporated for structural properties.

In the manufacturing approach, in one embodiment, the individual metallic layers in the bottom laminated or monolithic metal skins and the adhesive or fiber reinforced adhesive layers are placed in a bonding mold one sheet at a time. In another examples, the pre-manufactured narrow discrete straps constituting the core are put in place side-by-side to form the core. In another embodiment, this sequence of laminated or monolithic metal skins and core material can be repeated a number of times (e.g. up to 20 layers or in another example up to 7 layers). Finally, the top sheets are placed one-by-one over the core. In a further embodiment, the top skin, bottom skin, intermediate skins and core FML skins can be tapered 16 along the length and width by dropping internal layers of metal and layers of bonding materials 17 as shown in FIG. 1. Finally, in one embodiment, the skin/core lay-up is vacuum bagged and autoclave cured. However, in another embodiment, skins may be cured out of the autoclave using appropriate molding which would force the skins to conform to the lay-up mold. In either approach, all the internal layers conform to the curvature of the mold including pre-manufactured straps in the core. If necessary, in another embodiment thicker cores can be constructed of thin staggered cores which are bonded together in the final autoclave cure.

In another embodiment, when the bottom skin is a monolithic metallic skin, the bottom skin is pre-machined, preformed and/or combinations thereof and becomes the mold for the lay-up for the rest of the structural elements of core and skin layers. Then, the whole sandwich construction skin structure is cured at one time. The autoclave pressure or in some cases other molding pressure is used to form the individual layers into the final contoured shape. In yet another embodiment, the bottom mold surface becomes the bottom layer of the advanced hybrid structure. In other words, the bottom layer becomes the outer skin of the structure.

In one embodiment, the fatigue resistant FML core slows down crack growth in the laminated skins. Advanced hybrid laminated skins manufactured in this manner may provide one or more of the following more fatigue resistance, reduced crack growth and/or increased residual strength over the use of machined monolithic skins. In another embodiment, laminated metallic skins allow the use of multiple alloy/tempers and multiple prepreg fiber/matrix systems when FML bottom and/or top skins are used.

In one embodiment, the central core is comprised of stretched and/or non-stretched FML straps that are composed of either the same metal/fiber materials and fiber lay ups as the laminated skins they are reinforcing and/or different metal/fiber materials and fiber lay ups. In another embodiment, each core is comprised of a plurality of metallic laminate or fiber metal laminate straps which are pre-stretched or non-stretched and lain side-by side in the core region to fill the area between skins (e.g. plurality of strap may range from about 100 straps laid side by side to about 2 straps laid side by side). In one example, the reinforcing core and/or the FML straps are stretched to reverse the curing residual stresses in the FML and places the aluminum in compression. It is believed that this residual stress distribution makes the straps more fatigue insensitive. In another embodiment, the monolithic metal or laminated skins are laid up one layer at a time with the cores between each skin layer and bonded with adhesive or fiber reinforced adhesive and cured. This results in either substantially no residual stress when adhesive is used or a low level of tensile residual stresses in the metal when fiber/adhesive prepreg is used. Accordingly, under fatigue load, it is believed that the fatigue cracks will tend to grow in the skins and minimize fatigue in the core. Thus, it is believed that the core will “bridge” the crack retarding the crack growth in the skin. This “crack bridging” by the intact core should improve the fracture toughness of the sandwich structure damaged by cracks.

In one example under accidental damage scenarios, the central core of the present invention can improve fracture toughness because the discrete strap elements act as independent elements resisting fast fracture as the individual straps break as discrete elements (e.g. when the cracks propagating in the core strap width direction which is the direction of interest in wing structures reach the strap edges they must re-initiate in the next strap which takes more additional energy). In another embodiment, by providing a higher strength/and or higher stiffness FML construction, the core strap relative to the skin the result is increasing the crack bridging in fatigue loading and increasing the residual strength under accidental damage scenarios involving penetration of the skins.

The FML straps may be constructed of metallic layer reinforced by a fiber/matrix layer. Suitable material used for the fiber layer include but are not limited to glass, fibers or high modulus high strength fibers such as graphite, Zylon, or M5. Suitable high modulus fiber metal laminate straps may be, but are not limited to such emerging fibers such as Zylon or M5 fibers. In one instance, the straps that are used are non-stretched

In one embodiment, the laminated or fiber reinforced skins may be made either (1) from the same alloy temper sheet, or (2) various alloy/temper sheets may be combined to produce combinations of properties in each skin of the sandwich.

A further embodiment of the present invention is to use a monolithic thick sheet or thin skin for the bottom aerodynamic surface and a laminated skin on the inside surface of the wing. In another embodiment, the outer skin can be machined and tapered and formed to contour or in any combinations of the machining and forming sequences to achieve the final contour. This skin is now used as a mold for placement of the core and inner laminated or fiber reinforced skin. In yet another embodiment, the assembly could be vacuum bagged and pressure formed in the autoclave and then cured or appropriate molding can be used to form the skin before curing. The skins and cores would conform to the curvature of the bottom skin.

It will thus be seen that the object set forth above, among those made apparent from the preceding description are efficiently attained and, since certain changes may be made in the product set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention, which, as a matter of language, may be said to fall there between.

What is claimed is:

1. A method for producing an aircraft wing hybrid structure comprising the steps of:
producing a machined metallic bottom skin by either (i) pre-machining, (ii) preforming or (iii) combinations thereof;
finishing the machined metallic bottom skin;
providing a finished machined metallic bottom skin that serves as a lay-up mold;
placing a plurality of core straps on top of the finished machined metallic bottom skin;
arranging a skin that is selected from the group consisting of a monolithic skin, a fiber metal laminate skin and a non-reinforced metallic laminate skin on top of the plurality of cores strap to form a module; and
curing the module, wherein the finished machined metallic bottom skin is the load carrying element in the aircraft wing hybrid structure.

2. The method of claim 1, wherein core straps comprises at least two metal layers between which there is at least one fiber-reinforce polymer layer.

3. The method of claim 1, wherein the plurality of core straps are selected from the group consisting of non-stretched, pre-stretched and combinations thereof.

4. The method of claim 1, wherein at least one skin with core combination may be place inside the module where the skin is selected from the group consisting of a monolithic skin, a fiber metal laminate skin and a non-reinforced metallic laminate skin with fiber metal laminate strap cores between each skin.

5. A method for producing an aircraft wing hybrid structure comprising the steps of:
providing a lay-up mold;
placing a first skin that is selected from the group consisting of a monolithic skin, a fiber metal laminate skin and a non-reinforced metallic laminate skin on a lay-up mold;
placing a plurality of core straps on top of the skin;
arranging a second skin that is selected from the group consisting of a monolithic skin, a fiber metal laminate skin and a non-reinforced metallic laminate skin on top of the plurality of cores strap to form a module; and
curing the module.

6. The method of claim 5, wherein core straps comprises at least two metal layers between which there is at least one fiber-reinforce polymer layer.

7. The method of claim 5, wherein the first skin is a fiber metal laminate skin.

8. The method of claim 6, wherein the second skin is a fiber metal laminate skin.

9. The method of claim 5, wherein at least one skin with core combination may be place inside the module where the skin is selected from the group consisting of a monolithic skin, a fiber metal laminate skin and a non-reinforced metallic laminate skin with fiber metal laminate strap cores between each skin.
